(19) United States
(12) Patent Application Publication
(10) Pub. No.: US 2007/0235627 A1
(43) Pub. Date: Oct. 11, 2007

(54) Pocket bun pan

(76) Inventors: Tommy J. Leach, Jellico, TN (US); Farlin C. Morgan, Williamsburg, KY (US)

Correspondence Address: PITTS AND BRITTIAN P C, P O BOX 51295, KNOXVILLE, TN, 37950-1295, US

(21) Appl. No.: 11/390,871

(22) Filed: Mar. 28, 2006

(51) Int. Cl. B28B 7/24; B28B 7/26

(52) U.S. Cl. 249/121; 249/119

(57) ABSTRACT

A pocket bun pan for cooking pocket-shaped sandwich buns. The pocket bun pan includes a surface defining at least one mold, each mold providing a space for shaping a pocket-shaped sandwich bun. Each mold includes a ridge substantially surrounded by a cup.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to sandwich buns. More particularly, this invention pertains to a cooking pan for cooking a sandwich bun with a pocket to hold sandwich meat and condiments.

2. Description of the Related Art

Several types of meat-based sandwiches, such as hot dogs and hamburgers, are commonly consumed throughout the world. Such meat-based sandwiches typically include a cut of meat served on a bread bun. Conventionally, a hot dog bun consists of an elongated bread bun. The bread bun is sliced lengthwise to a partial depth, in order to facilitate insertion of both a hot dog and accompanying condiments.

Hot dogs and other meat-based sandwiches are often eaten with a wide variety of condiments. The most common condiments used in meat-based sandwiches are mustard, ketchup, chili, dill pickles, sauerkraut, coleslaw, pickle relish, and chopped onion. However, mayonnaise, chopped lettuce, tomato, cheese, and many other condiments are also commonly used.

When serving a hot dog with large quantities of sauce-based condiments in a conventional hot dog bun, the lengthwise slice of the hot dog bun often results in the condiments dripping out of the ends of the bun. Furthermore, when the slice of the hot dog bun is torn too far open, the hot dog bun splits into two halves, allowing condiments to drip out from beneath the hot dog. These phenomena frequently create messing on the consumer's clothing and surrounding area and often result in a waste of the dripped condiments.

### BRIEF SUMMARY OF THE INVENTION

A pocket bun pan for cooking pocket-shaped sandwich buns is disclosed. The pocket bun pan includes a surface defining at least one ridge surrounded by a corresponding cup. Each ridge and corresponding cup cooperate to define a mold. In one embodiment, each mold is substantially oblong, such as to provide a space for shaping a pocket-shaped hotdog bun. In another embodiment, each mold is substantially cylindrical, such as to provide a space for shaping a pocket-shaped hamburger bun.

In more discriminate embodiments, a lid is provided for each mold. The mold and the lid cooperate to substantially enclose the ridge and to define a space for shaping a pocket-shaped sandwich bun. In one embodiment, the pocket bun pan includes a sheet defining a plurality of lids, each lid being configured along the sheet such that each lid registers to a mold defined by the surface. In another embodiment, an individual lid is provided for each mold.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a pocket bun pan constructed in accordance with several features of the present invention;

FIG. 2 is a cross-sectional side view of the pocket bun pan of FIG. 1;

FIG. 3 is a perspective view of a pocket bun created using the pocket bun pan of FIG. 1;

FIG. 4 is a perspective view of another embodiment of a pocket bun pan constructed in accordance with several features of the present invention;

FIG. 5A is a cross-sectional view of a pocket bun created using the pocket bun pan of FIG. 3, showing a pocket-shaped hamburger bun half combined with one half of a conventional hamburger bun;

FIG. 5B is a cross-sectional view of another pocket bun created using the pocket bun pan of FIG. 3, showing two pocket-shaped hamburger bun halves combined to form a complete bun;

FIG. 6 is a perspective view of another embodiment of a pocket bun pan constructed in accordance with several features of the present invention;

FIG. 7 is a perspective view of another embodiment of a pocket bun pan constructed in accordance with several features of the present invention.

### DETAILED DESCRIPTION OF THE INVENTION

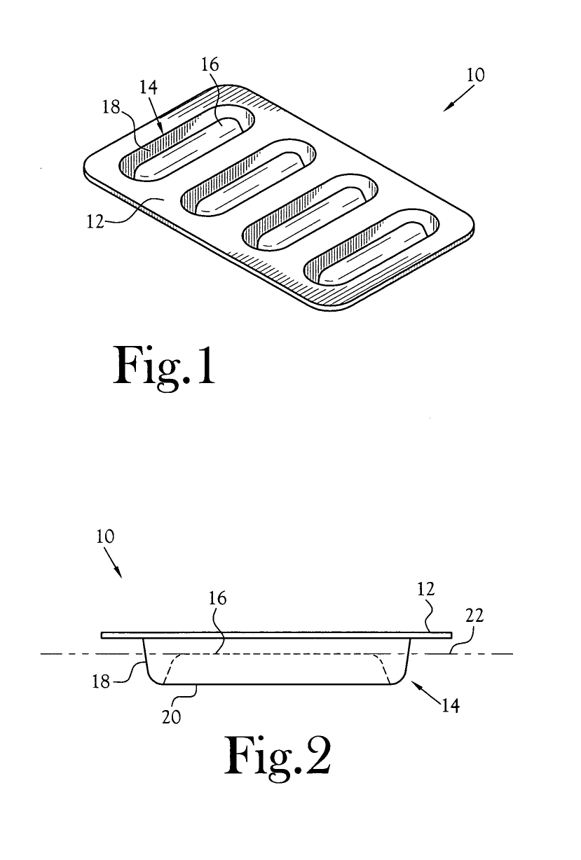

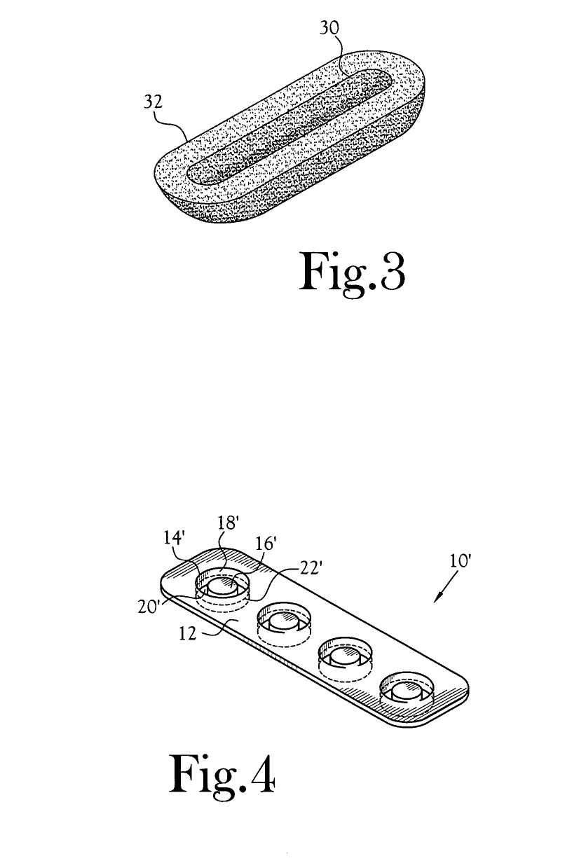

A pocket bun pan for cooking pocket-shaped sandwich buns is disclosed. The pocket bun pan, illustrated in perspective at 10 in FIG. 1, includes a surface 12 defining at least one ridge 16 surrounded by a corresponding cup 18. Each ridge 16 and corresponding cup 18 cooperates to define a mold 14. When the mold 14 is substantially filled with bread, the ridge 16 defines an opening 30 of partial depth in the bread 32, thereby forming a pocket-shaped sandwich bun (See FIG. 3).

FIG. 2 is a cross-sectional side view of one embodiment of a pocket bun pan 10 constructed in accordance with several features of the present invention. In the illustrated embodiment of FIG. 2, the pocket bun pan 10 is configured to produce pocket-shaped sandwich buns to accompany a typical hot dog or sausage. The cup 18 is defined by a substantially oblong depression in the surface 12. The depression forms a plurality of sidewalls connected by a bottom surface portion 20. The bottom surface portion 20 of the cup 18 is raised to a partial elevation 22 in the cup 18 to define a substantially oblong ridge 16 slightly larger than a typical hot dog or sausage. The ridge 16 terminates at the partial elevation 22 in the mold 14. In this configuration, the mold 14 defines a space for shaping a bun with oblong dimensions corresponding to the shape of the cup 18 and with an opening having oblong dimensions corresponding to the shape of the ridge 16.

In use, a user places into the mold 14 an amount of bread dough sufficient to substantially cover the ridge 16 when cooked. The user then cooks the bread dough in the pocket bun pan 10. FIG. 3 is a perspective view of a pocket bun created using the pocket bun pan of the present embodiment. As shown in FIG. 3, once cooked, the user removes and inverts the cooked bread dough to reveal a bun 32 defining an opening 30 formed by the ridge 16. The user is then able to selectively insert any of a variety of food products into the opening 30.

FIG. 4 is a perspective view of another embodiment of the pocket bun pan 10′ of the present invention. In this configuration, the pocket bun pan 10′ is configured to produce pocket-shaped sandwich buns to accompany a typical hamburger or other round sandwich meat. As shown in FIG. 4, the cup 18′ is defined by a substantially cylindrical depression in the surface 12, forming a cylindrical side wall with a bottom surface portion 20′. The ridge 16′ is defined by a substantially cylindrical pedestal protruding upwardly from the bottom surface portion 20′ of the cup 18′ and terminating at a partial elevation 22′ in the mold 14′. In this configuration, the mold 14′ defines a space for shaping one half of a hamburger bun. The one half of the hamburger bun is formed with rounded dimensions corresponding to the substantially cylindrical shape of the cup 18′ and with an opening having rounded dimensions to hold a typical hamburger, or other round sandwich meat, with accompanying condiments.

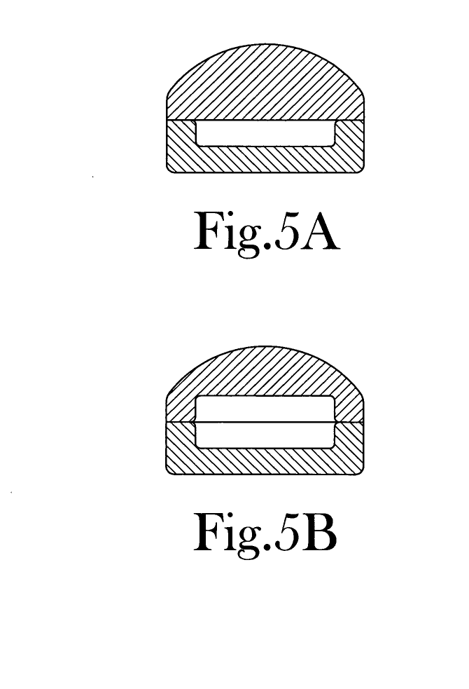

Two applications of the embodiment of the pocket bun pan 10′ of FIG. 4 are illustrated in FIGS. 5A and 5B. Referring to FIG. 5A, a pocket-shaped hamburger bun half, created with the pocket bun pan 10′, is combined with one half of a conventional hamburger bun to form a complete bun with a substantially enclosed pocket. As shown in FIG. 5B, two pocket-shaped hamburger bun halves are combined to form a complete bun with a substantially enclosed pocket. A user is able to selectively insert any of a variety of food products into the substantially enclosed pocket by separating the hamburger bun halves, inserting the food product, and then rejoining the hamburger bun halves.

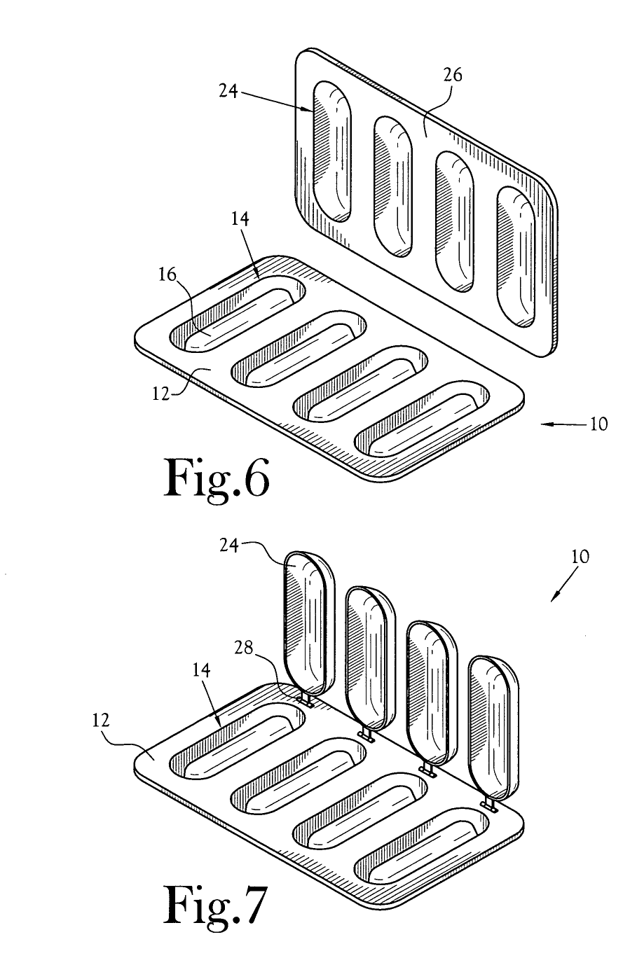

In one embodiment, illustrated in FIG. 6, a lid 24 is provided for each mold 14. Each lid 24 is defined by a substantially concave surface sized to cover a corresponding mold 14. The mold 14 and the lid 24 cooperate to substantially enclose the ridge 16 and to define a space for shaping a pocket-shaped sandwich bun. In the illustrated embodiment, a sheet 26 is provided having dimensions such as to allow the sheet 26 to register with the surface 12. In this embodiment, the sheet 26 defines one lid 24 for each mold 14 in the surface 12, with each lid 24 being configured along the sheet 26 so as to substantially register to and cover a corresponding mold 14 when the sheet 26 and the surface 12 are brought into substantial registration. In another embodiment, shown in FIG. 7, each lid 24 is independently and selectively positionable proximate each mold 14. In the illustrated embodiment, each lid 24 is movably secured to the surface 12 proximate a corresponding mold 14 by a hinge 28 or other suitable fastener. Of course, those skilled in the art will recognize that numerous other configurations for the lid 24 exist and can be used without departing from the spirit and scope of the present invention.

Each of the various illustrated embodiments depicts a surface 12 defining an array of multiple molds 14. However, it will be understood by those skilled in the art that the surface 12 can define any number of molds 14 in any number of configurations without departing from the spirit and scope of the present invention. For example, a surface 12 defining a single mold 14 is suitable for a small-scale cooking operation, such as personal use to bake a single pocket-shaped sandwich bun. Likewise, a surface 12 defining numerous molds 14 is suitable for a large-scale cooking operation, such as an industrial bakery or other such enterprise.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A pocket bun pan for cooking pocket-shaped sandwich buns, said pocket bun pan comprising:
a surface defining at least one mold, each of said at least one mold comprising:
at least one side wall defining a perimeter; and,
a bottom connecting said side walls, said bottom defining a ridge upwardly extending and substantially central to said side walls.

2. The pocket bun pan of claim 1 further including at least one lid positionable proximate said at least one mold, whereby said lid and said mold cooperate to substantially enclose said ridge and to define a space for shaping a pocket-shaped sandwich bun.

3. The pocket bun pan of claim 1 further including at least one lid positionable proximate said at least one mold, said lid comprising a substantially concave surface, whereby said lid and said mold cooperate to substantially enclose said ridge and to define a space for shaping a pocket-shaped sandwich bun

4. The pocket bun pan of claim 1 further including at least one lid movably attached to said surface proximate said at least one mold, whereby said lid and said mold cooperate to substantially enclose said ridge and to define a space for shaping a pocket-shaped sandwich bun.

5. The pocket bun pan of claim 1 further including at least one lid movably attached to said surface proximate said at least one mold, said lid comprising a substantially concave surface, whereby said lid and said mold cooperate to substantially enclose said ridge and to define a space for shaping a pocket-shaped sandwich bun.

6. The pocket bun pan of claim 1 further including a sheet defining at least one lid, each of said at least one lid comprising a substantially concave surface, each of said at least one lid being configured along said sheet such that each of said at least one lid registers to at least one mold.

7. The pocket bun pan of claim 1 wherein said ridge extends upwardly from said bottom and terminates at a partial elevation of said mold.

8. The pocket bun pan of claim 1, wherein said side walls are defined by a substantially cylindrical depression in said surface, and wherein said ridge is defined by a substantially cylindrical pedestal protruding upwardly from said bottom.

9. The pocket bun pan of claim 1, wherein said side walls are defined by a substantially oblong depression in said surface, and wherein said ridge is defined by a substantially oblong portion of said bottom protruding upwardly and substantially central to said side walls.

10. A pocket bun pan for cooking pocket-shaped sandwich buns, said pocket bun pan comprising:
a surface defining at least one mold, each of said at least one mold comprising:
at least one side wall defined by a substantially oblong depression in said surface; and,
a bottom connecting said side walls, said bottom defining a substantially oblong ridge upwardly extending and substantially central to said side walls, said substantially oblong ridge protruding upwardly from said bottom to a partial elevation of said mold.

11. The pocket bun pan of claim 10 further including at least one lid positionable proximate said at least one mold, whereby said lid and said mold cooperate to substantially enclose said ridge and to define a space for shaping a pocket-shaped sandwich bun.

12. The pocket bun pan of claim 10 further including at least one lid positionable proximate said at least one mold, said lid comprising a substantially concave surface, whereby said lid and said mold cooperate to substantially enclose said ridge and to define a space for shaping a pocket-shaped sandwich bun

13. The pocket bun pan of claim 10 further including at least one lid movably attached to said surface proximate said at least one mold, whereby said lid and said mold cooperate to substantially enclose said ridge and to define a space for shaping a pocket-shaped sandwich bun.

14. The pocket bun pan of claim 10 further including at least one lid movably attached to said surface proximate said at least one mold, said lid comprising a substantially concave surface, whereby said lid and said mold cooperate to substantially enclose said ridge and to define a space for shaping a pocket-shaped sandwich bun.

15. The pocket bun pan of claim 10 further including a sheet defining at least one lid, each of said at least one lid comprising a substantially concave surface, each of said at least one lid being configured along said sheet such that each of said at least one lid registers to at least one mold.

16. A pocket bun pan for cooking pocket-shaped sandwich buns, said pocket bun pan comprising:
a surface defining at least one mold, each of said at least one mold comprising:
at least one side wall defined by a substantially cylindrical depression in said surface; and,
a bottom connecting said side walls, said bottom defining a substantially cylindrical pedestal upwardly extending and substantially central to said side walls, said substantially cylindrical pedestal protruding upwardly from said bottom to a partial elevation of said mold; and,
a sheet defining at least one lid, each of said at least one lid comprising a substantially concave surface, each of said at least one lid being configured along said sheet such that each of said at least one lid registers to at least one mold.

17. The pocket bun pan of claim 16 further including at least one lid positionable proximate said at least one mold, whereby said lid and said mold cooperate to substantially enclose said pedestal and to define a space for shaping a pocket-shaped sandwich bun.

18. The pocket bun pan of claim 16 further including at least one lid positionable proximate said at least one mold, said lid comprising a substantially concave surface, whereby said lid and said mold cooperate to substantially enclose said pedestal and to define a space for shaping a pocket-shaped sandwich bun

19. The pocket bun pan of claim 16 further including at least one lid movably attached to said surface proximate said at least one mold, said lid comprising a substantially concave surface, whereby said lid and said mold cooperate to substantially enclose said pedestal and to define a space for shaping a pocket-shaped sandwich bun.

20. The pocket bun pan of claim 16 further including a sheet defining at least one lid, each of said at least one lid comprising a substantially concave surface, each of said at least one lid being configured along said sheet such that each of said at least one lid registers to at least one mold.
